(19) United States
(12) Patent Application Publication
(10) Pub. No.: US 2017/0041540 A1
(43) Pub. Date: Feb. 9, 2017

(54) Energy-efficient secure vision processing applying object detection algorithms

(71) Applicants: Ronald B Foster, Fayetteville, AR (US); Scott Gardner, Austin, TX (US); Parviz Palangpour, Austin, TX (US)

(72) Inventors: Ronald B Foster, Fayetteville, AR (US); Scott Gardner, Austin, TX (US); Parviz Palangpour, Austin, TX (US)

(21) Appl. No.: 15/227,949

(22) Filed: Aug. 3, 2016

Related U.S. Application Data
(60) Provisional application No. 62/200,648, filed on Aug. 4, 2015.

(51) Int. Cl. H04N 5/232; H04N 7/18; G06K 9/66; H04N 7/01

(52) U.S. Cl. CPC H04N 5/23241; H04N 5/23245; H04N 7/0127; H04N 7/188; H04N 7/183; G06K 9/66

(57) ABSTRACT

Energy is optimized in a battery-powered camera system by co-locating a low-power vision processor with a camera. The vision processor executes algorithms to determine whether the image contains one or more objects of interest. Convolutional neural network is one example of an object detection algorithm. Energy is saved by making local decisions to turn off the camera for one or more subsequent frames, and by avoiding energy expenditure for compression and transmission. Security is optimized by transmitting only information about the images, as opposed to images themselves. Alternatively, security may be enhanced by completing a first portion of an object detection algorithm on a local processor, then transmitting interim data to a remote computer where a second portion of the algorithm is completed. It is challenging to obtain original image data from transmitted interim data.

### BACKGROUND OF THE INVENTION

Camera technologies are now substantially cost-reduced, allowing for broad deployment and collection of images from many different nodes. In principle, smart cameras can be placed almost anywhere. However, issues that prevent such broad deployment are: 1) proliferation of wiring; 2) energy consumption; 3) security concerns; and 4) costs of storage and retrieval of image data. The first issue can be addressed by simply making a system battery operated, with WiFi connection. This allows for easy placement of cameras with few constraints. However, energy consumption must generally be substantially reduced to enable battery operation. With a battery-operated smart camera, the primary energy costs relate to acquiring an image, optionally compressing the image, and then wirelessly transmitting the image data. Additional energy costs are incurred in storing the image data, and later in retrieving data of interest. Because data is often stored in the cloud, the energy costs of such storage are not transparent a user. Regardless, energy costs are a significant portion of the overall costs of operating a server farm.

In many consumer applications, there is a growing concern about security. A particular concern is that devices placed in the home transmit images that might be intercepted by an adversary. One solution is to encrypt images prior to transmission, but encryption incurs additional energy costs. In addition, increased computing power steadily erodes the barriers to decryption. Solutions to make it more difficult to break encryptions result in further increase in energy consumption, which is going in the wrong direction.

In those cases where security concerns are paramount, there is a need to convert image data to a reduced format, such that useful information can be extracted from transmitted data, but the image cannot be reconstructed. Fortunately, there is often no need to possess identifiable personal data in order to perform meaningful visual analysis. For example, visual sensor networks might be applied in retail analytics, elderly care, or factory monitoring. In each of these examples, information is required, but personal data is not required and can optionally be discarded. Obviously, it is best to discard personal data as soon as possible in the process of handling images. There is a need for systems, methods and processes that extract information from images and then discard the image itself, or alternatively obfuscate the image data such that the original image is not recognizable.

There is a need for camera-based systems that are less susceptible to hacking. Most desirable is a camera with local processor that only transmits meta-data, or information about images, but not the images themselves. In the case where images are transmitted to a base station designed to both transmit and receive, security against hacking is necessarily reduced.

There is a need for a processor that is co-located with both a camera and a radio that transmits information but does not receive instructions.

There is a need to substantially reduce energy consumption for acquiring, compressing, encrypting, transmitting, and storing images and other data, and in retrieving such data on demand.

### BRIEF SUMMARY OF THE INVENTION

Vision processing involves extracting information from images. In those cases where the primary value of an image is just the information itself, the image data can be discarded after the information has been extracted. In addition, the information extracted from a given image can often be used in support of decisions on whether to ignore subsequent image data.

Energy consumption with vision processing systems is of growing importance as such systems are proliferated in various applications. Clearly, energy must be expended to acquire images from a sensor. Following that step, efforts might be applied to minimize the overall energy consumed by the entire system, or alternatively the energy consumed by a local system. In the case where a local subsystem is battery-operated, while the remainder of the system has access to a wall plug, optimization of energy used by the local subsystem is obviously most important.

One opportunity is to locally evaluate the present image data and make a decision on whether it is interesting by executing algorithms operating on a local subsystem that includes a camera. When data is determined to be uninteresting, actions can be taken to conserve energy and extend battery life. First, the camera frame rate can be reduced, effectively placing the camera in a monitoring mode. Second, the costs of compressing, transmitting and storing the image data can be avoided by simply ignoring selective data. When uninteresting data is ignored, there is an additional benefit in data mining, in that a smaller database will be examined when extracting information.

Assuming that computation capability can be co-located with the image sensor, then minimizing the energy expenditure of the local system involves making a tradeoff between computation energy consumed to evaluate and make a decision, and energy spent to prepare data, then transmit the data to a remote location. Once a decision is made to ignore subsequent image data for some time, the image sensor can be turned off or placed in a sleep mode where substantially less energy is drawn compared to an active mode. With current state-of-the-art, significant computation is required to execute object detection algorithms, and associated energy demands are heavy. Consequently, co-location of computation with a battery-powered image sensor is impractical in most circumstances. However, with a low-power vision processor dedicated to executing the computation, there is potential for local computation to result in overall energy reduction. One example of such a low-power vision processor is described in WO2014039210, which is attached herein by reference. With this approach, a master processor fetches instructions and conveys them to datapath processors that are termed “tile processors”. The key advantage of this approach is that it enables programmable vision processing with throughput approaching that of hardwired solutions. It is understood that a tile processor is just one example of a processor that is capable of performing the required computation, and the invention is not limited to this specific type of processor.

For example, current state-of-the-art image sensors consume about 90-400 mW while outputting 720 p video at 30-60 frames per second. This equates to about 1.5-15 mJ/frame. Compression consumes about 10-800 mJ/frame, depending on many details. For example, in the case of security and surveillance applications where the image is relatively unchanging from frame-to-frame, inter-frame compression is often applied. Such inter-frame compression has the advantage of reducing the number of bits to be transmitted by perhaps 50-1,000 times; but carries the disadvantage of requiring more complex computation and associated increased energy consumption. The energy to power a radio and transmit data depends strongly on distance to the receiver and the exact protocol used. Generally, energy consumption for data transmission may require 200-2,000 mJ/frame for uncompressed 720 p images. Due to complexity of available options for compressing and transmitting data, detailed study of tradeoffs must be completed during system design.

Consider the case of 5 mJ/frame to acquire an image, a compression algorithm consuming 100 mJ/frame while reducing file size 1,000 times, and 2 mJ/frame to transmit the compressed image. The breakeven occurs when local computation indicates that the specific image does not contain one or more objects of interest and can be ignored, while consuming 102 mJ/frame. In this case, energy for computation is substituted for energy for compression and transmission. However, the energy savings are dramatically leveraged when local computation results in a decision that subsequent images can be ignored, and the camera is put into a mode that minimizes energy consumption for some extended time.

In the case of security and surveillance applications, a motion detector is often applied to determine when to power a camera and begin acquiring images. With local computation to determine that the source of the motion is not an object of interest and can therefore be ignored, the camera can be powered down for at least several frames. When motion persists, the check for objects of interest can be repeated by capturing another frame after some elapsed time. When the local computation output is an indication that the specific image does in fact contain one or more objects of interest, typically many subsequent frames will be captured in the form of a video. The additional energy cost of local computation will be allocated over several frames, with modest impact.

In a first embodiment, a battery-powered subsystem comprises a vision processor that is co-located with a camera and executes an algorithm to extract information from an image and determine whether the image contains one or more objects of interest. When the output of the algorithm is an indication that the image can be ignored, energy is saved by turning off the camera for one or more subsequent frames, and by avoiding energy expenditure for compression and transmission.

Many algorithms have been successfully applied to extract information from images, and specifically to detect objects in images. One example of an algorithm applied to object detection is convolutional neural network (CNN), which is well known in the art. Other well-known examples are Scale-invariant Feature Transform (SIFT), Speeded Up Robust Features (SURF), and Histogram of Oriented Gradients (HOG). One skilled in the arts will recognize that there are many other object detection algorithms, as well as variations of the ones listed above.

CNN methodology is useful for extracting information from images, and specifically for recognizing objects in images. CNNs are comprised of multiple layers of neurons. For example, each neuron might operate on only a sub-region of the input image. The sub-regions effectively overlap such that the entire image is operated on by one or more neurons.

Neuron clusters may also be pooled into a new layer, either locally or globally. A given layer may be fully connected to a subsequent layer, in which case element-wise nonlinearity is applied on a layer-by-layer basis, and weights are assigned to define the nonlinearity. Alternatively, a convolution operation can be performed to combine information from one or more clusters. Convolution is often applied to reduce the large number of parameters that must be defined with fully connected layers. With convolution, required memory size is reduced and performance is improved.

Starting with the original input image, the output of a convolution layer is a feature map, resulting from the dot product of the respective neuron's weights and its sub-region of the input image. Since the convolution operation is deterministic, an adversary might reconstruct the original image by iteratively guessing the weights that were applied. However, assume that the output of a first convolution layer is applied as the input to a second convolution layer, and a second output is generated. At that point, it would be very challenging to start with the output of the second convolution layer and reconstruct the original image. Attempts to reconstruct the original image would rely on exhaustively testing different combination of convolutions and weights, and checking the reproduced data for validity as a useful image. As one can easily imagine, following a third convolutional layer, it becomes virtually impossible to reconstruct the original images from the output alone.

A mathematical prediction of the likelihood of being able to recover the original image will depend on the number of bits included in the original image, the number of weights assigned on a layer-by-layer basis, the range of values of the respective weights, and the algorithm applied to test and verify that the original image has been recovered. However, for reasonable assumptions it can be concluded that it is extremely challenging to recover an original image beginning with the output of a third convolutional layer.

A typical CNN algorithm might rely on a mixture of convolutional, pooling, non-linear operator, and fully connected layers. For example, 4-20 layers or more might be used. Since the output of a given layer is effectively a translation of the image data, such output can be described as meta-data. That is, the layer output contains information about the original image data, but does not contain the original content.

A particular application of CNN to extract information from an image is object detection. To implement this approach, a neural network is trained based on an initial database of classified images. Subsequently, new images are processed by the CNN algorithm and the probability that a given defined class of objects is present in the new image is computed.

The different types of layers and their relative reversibility are discussed below:
Convolution layer
   Input can be recovered (via deconvolution) from the output if the weights are known. However, both an output and its respective input as reference must be available to systematically recover the kernels and weights.
Pooling layer
   The typical operator is 2×2 max-pooling (select the maximum value of the neighborhood of 4). This is obviously not reversible, since there is no way to recover the four inputs if only the single (max) output is known.
Non-Linear Operator layer
   For example, f(x)=max(0, x), which just clamps the output for negative values. This is not reversible for values of less than 0.
Fully-connected layer
   Since this is just matrix multiplication, it can be inverted and reversed.

Convolutions provide a high degree of immunity to reversibility, and therefore are relatively secure. It is also noted that Pooling and Non-Linear Operator layers are specifically non-reversible. Therefore, the difficulty of reversing an interim output, or the computation output from a given layer, grows rapidly with number of layers.

Reversing the output of a CNN algorithm, whether final or interim, would require that many parameters be provided. The original data is obfuscated by combination of convolution, pooling, and non-linear operations. Therefore, application of CNN will result in a high level of security that is equivalent to or superior to encryption.

To satisfy security concerns with transmission of image data, one obvious approach is to apply encryption prior to transmission, and decryption following receipt. While encryption methods have quantifiable advantages in resisting brute-force adversarial attacks, in fact there is a much higher likelihood of success when applying social engineering approaches. If an adversary can obtain the private key by any method, then encryption fails entirely.

One embodiment of the present invention applies an object detection algorithm to extract information from image data. Interim data will be transmitted, for example in the form of the output from a minimum of three convolutional layers. Upon receipt of interim data, computation of any remaining layers, whether fully connected, convolutional or other, will be completed, and the output made available to the user. A key advantage of this approach is that the workload of executing the object detection algorithm is divided between local and remote subsystems. For a battery-operated camera system, perhaps half or more of the energy consumption to execute the object detection algorithm can be transferred to the remote system. A second advantage is that an adversary intercepting transmitted data cannot make use of this data to recover the original image. Furthermore, since the quantity of data that is transmitted may be substantially reduced compared to the original image data, the energy required to transmit interim data is reduced.

Optionally, lossless compression may be applied prior to transmission of interim data. Additionally, it is noted that transmission of interim data does not preclude use of encryption/decryption. However, the energy costs of lossless compression and encryption must be included in an optimization analysis.

### BRIEF DESCRIPTION OF THE SEVERAL VIEWS OF THE DRAWINGS

FIG. 1 is a block diagram of a typical camera system where compressed data is transmitted to a remote computer.

FIG. 2 is a block diagram of a typical camera system where compressed data is transmitted to a base station, and thence to a cloud server.

FIG. 3 is a block diagram of the inventive system where a camera is co-located with a vision processor that executes object detection and develops a decision on whether to transmit data.

FIG. 4 is a block diagram of the inventive system where a camera is co-located with a vision processor that executes object detection and develops a decision on whether to transmit data.

FIG. 5 is a block diagram of the inventive system where a camera is co-located with a vision processor that executes object detection and develops a decision on whether to transmit data.

FIG. 6 is an illustration of an example CNN algorithm having multiple layers, along with the output file size in bytes from each layer.

### DETAILED DESCRIPTION OF THE INVENTION

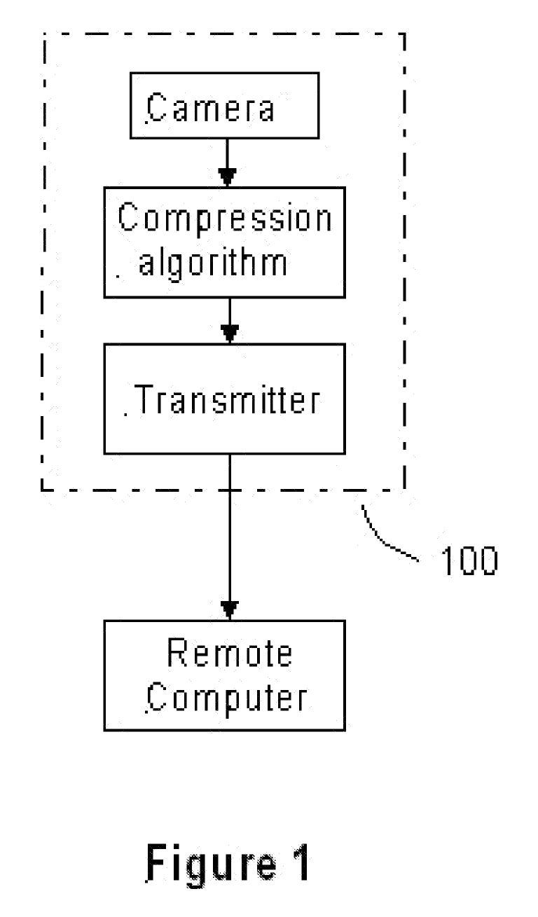

A typical local camera subsystem includes a camera and means to transmit image data to a remote computer. Since the energy costs of transmission, for example by WiFi, are relatively high, optionally the system will include means to compress data prior to transmission to a remote computer. In FIG. 1, local subsystem 100 incorporates the camera, optional compression algorithms, and a transmitter. Sophisticated compression algorithms are available, allowing for many choices in trading off energy consumed by compression vs. transmission. To optimize battery life in a battery-operated camera subsystem, aggressive compression is generally favorable. For example, compression may range from 1:30 to perhaps 1:3000, depending on various details. When the camera is staring at a relatively static scene, as is often the case with security and surveillance cameras, inter-frame compression enables higher compression ratios, but carries larger energy costs. When transmission must be over distance of 100 meters or more, a high-power radio must be used yet higher compression ratios still often result in lowest overall energy drain.

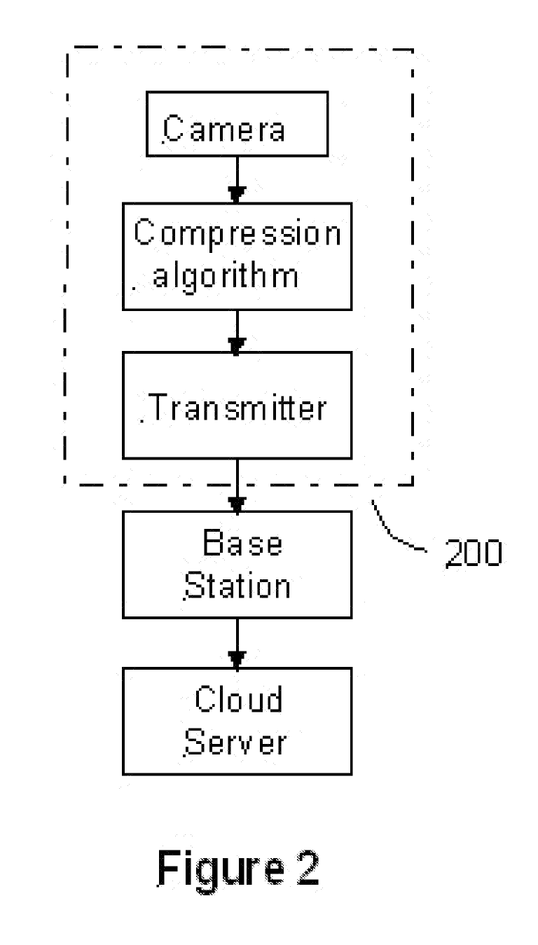

A local camera subsystem may include a camera and means for compression and transmission of image data to a remote computer. In FIG. 2, local subsystem 200 incorporates the camera, optional compression algorithms, and a transmitter. The remote computer is comprised of a base station and a cloud server. Typically, with such a system the base station is connected to both a wall plug for power and a wired or optical high-speed internet connection. Images may be stored on a cloud server in compressed format, and later streamed on demand. Decompression algorithms reside on the cloud server to support streaming or other access to images.

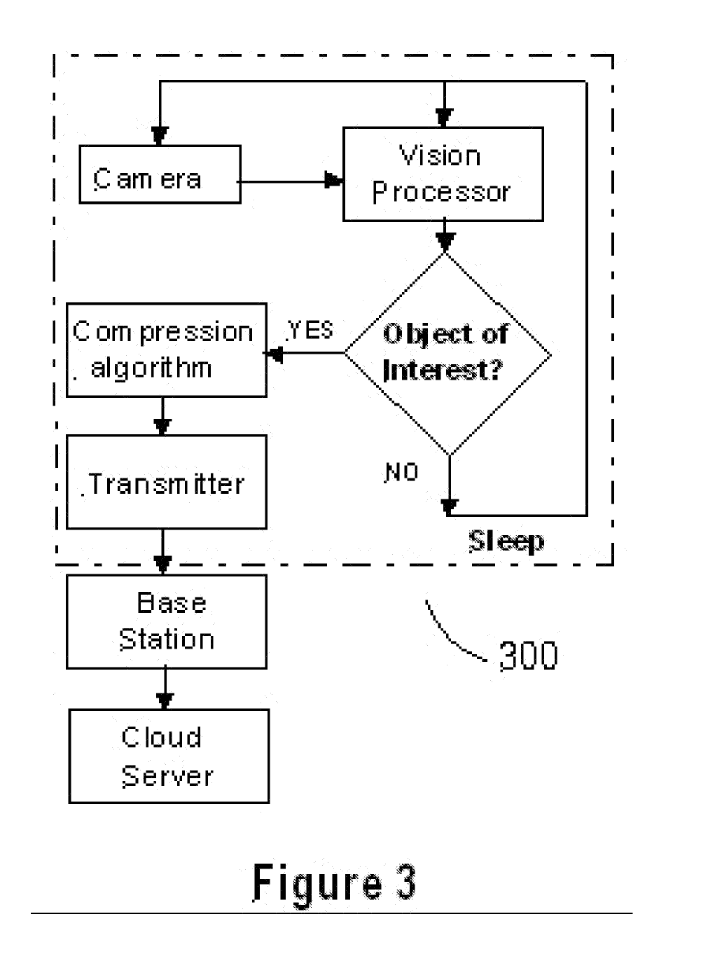

In FIG. 3, the inventive battery-operated local subsystem 300 includes a camera, means for detecting whether one or more objects of interest are present in an image, and optionally means for compression and transmission. FIG. 3 illustrates the output of an object detection algorithm, which is a decision. In the case where no objects of interest are detected in an image, the camera and vision processor can be slept, or otherwise placed in a minimum energy-consumption mode. When an object of interest is detected, multiple options are available. First, the image that was analyzed can simply be compressed and transmitted. A second option is to transmit only information, for example the decision on object detection, to a remote computer. The remote computer might include a base station and cloud server. For example, information about detected objects may be communicated in the form of text. A third option is to locally store the decision in a log file for later retrieval. In cases where the user does not need to access the decision, the energy associated with transmission can be saved, while perhaps a lesser amount of energy is consumed to store the output.

A fourth option is to transmit interim object detection data to a remote computer. In this case, the object detection algorithm may be started at the local subsystem and completed by the remote computer. The advantages of this approach are that with appropriately chosen interim data, the data to be transmitted is already compressed. In addition, with division of workload, only a portion of the energy required to complete the object detection algorithm is drawn from the battery. Finally, the data that is transmitted is secure. It is very challenging to recover the original image data from the interim data. Conveniently, the object detection algorithm might be CNN.

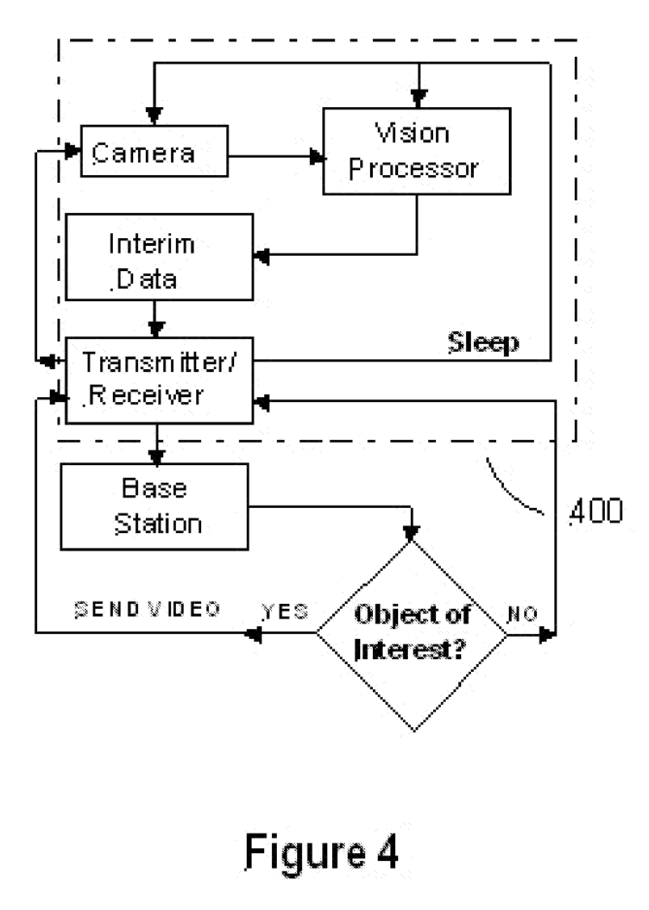

In FIG. 4, local subsystem 400 incorporates the camera, a vision processor for executing a first portion of an object detection algorithm, and means for transmitting and receiving. A first portion of object detection algorithm is completed, and interim data is transmitted to a remote base station. Optionally, a lossless compression algorithm is used to reduce the file size prior to transmission. The remote base station performs decompression as appropriate, then completes the object detection algorithm and develops the output, which is a decision. The base station transmits a signal to local subsystem 400 indicating whether video should be sent or the camera and vision processor can be slept, or otherwise placed in a minimum energy-consumption mode. The signal transmitted by the base station is received by the local transmitter/receiver and passed to the vision processor. For maximum security against hacking, the local receiver may have limited capability to receive very simple communications, while specifically not having capability to received processor-related instructions.

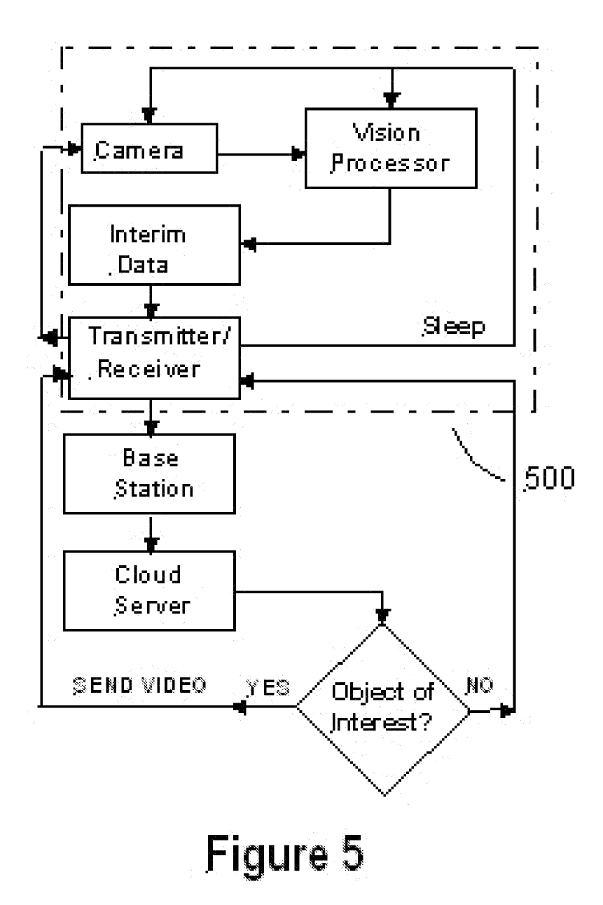

In FIG. 5, local subsystem 500 incorporates the camera, a vision processor for executing a first portion of an object detection algorithm, and means for transmitting and receiving. A first portion of object detection algorithm is completed, and interim data is transmitted to a remote base station, which is then further transmitted to a cloud server. Again, a lossless compression algorithm may optionally be used to reduce the file size prior to transmission. The cloud server completes the object detection algorithm and develops the output, which is a decision. The cloud server transmits a signal to the base station. The base station in turn transmits a signal to local subsystem 500 indicating whether the camera and vision processor can be slept, or otherwise placed in a minimum energy-consumption mode; or video should be sent. The signal transmitted by the base station is received by the local transmitter/receiver and passed to the vision processor. Again, for maximum security the local received may have limited.

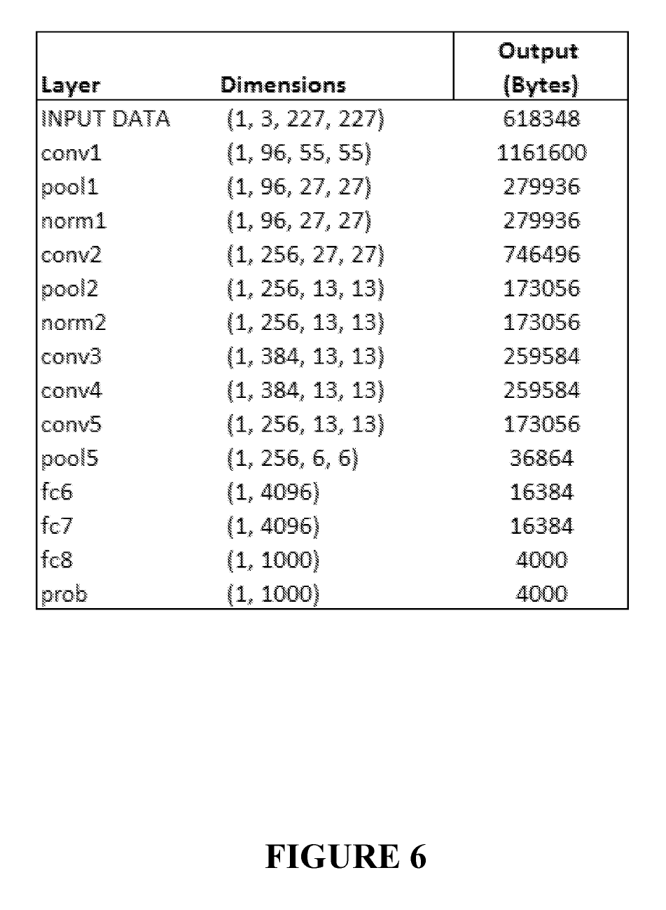

A typical neural network consists of several layers, often including convolutional, pooling, fully connected and non-linear operations. FIG. 6 is an illustration of an example CNN algorithm having multiple layers. The output of each computation layer is a data file, with the number of bytes shown. After five convolutional layers and a following pooling layer, the data file is about 17 times smaller than the input data file. This would be a convenient choice for transmission of data. Optionally, the file can be further reduced using lossless compression prior to transmission, for a total reduction of about 68 times relative to the input file. With a modest amount of computing power, the algorithm can be completed at a remote site. Key advantages of this approach are reduction of energy expenditure by a local battery-operated subsystem, and improved security, in that the transmitted data is not at all recognizable as an image. Furthermore, it would be very challenging to intercept the transmitted data and reconstruct the original image.

1) A camera system is comprised of a camera, a vision processor co-located with the camera and executing an object recognition algorithm, and means for transmission of data to a remote computer, wherein:
said camera acquires an image;
said vision processor executes an object recognition algorithm and outputs an indication on whether one or more objects of interest are included in the image;
when indication is that no objects of interest are present in the image the camera and vision processor are placed in a mode to minimize energy consumption for a time equal to at least one frame period at the specified frame rate;
when indication is that one or more objects of interest are present in the image, a video stream is initiated, video is compressed and transmitted to a remote computer.

2) The camera system of claim 1 wherein said vision processor comprises a master processor and one or more tile-based processors.

3) The camera system of claim 2 wherein transmission to a remote computer is wireless.

4) The camera system of claim 1 wherein transmission to a remote computer is wired.

5) The camera system of claim 1 wherein said object recognition algorithm comprises a neural network.

6) The camera system of claim 1 wherein said object recognition algorithm comprises a convolutional neural network.

7) A camera system is comprised of a camera, a vision processor co-located with the camera and executing an object recognition algorithm, and means for transmission of data to a remote computer, wherein:
said camera acquires an image;
said vision processor executes an object recognition algorithm and outputs an indication on whether one or more objects of interest are included in the image;
when indication is that no objects of interest are present in the image the camera and vision processor are placed in a mode to minimize energy consumption for a time equal to at least one frame period at the specified frame rate;
when indication is that one or more objects of interest are present in the image, a message is prepared for transmittal to a remote computer.

8) The camera system of claim 7 wherein said vision processor comprises a master processor and one or more tile-based processors.

9) The camera system of claim 8 wherein transmission to a remote computer is wireless.

10) The camera system of claim 7 wherein transmission to a remote computer is wired.

11) The camera system of claim 7 wherein said object recognition algorithm comprises a neural network.

12) The camera system of claim 7 wherein said object recognition algorithm comprises a convolutional neural network.

13) A camera system is comprised of a camera, a vision processor, and means for wireless transmission of data to a remote computer, wherein:
said camera acquires an image;
said vision processor completes at least a first portion of an object detection algorithm;
interim data is wirelessly transmitted to a remote computer;
said remote computer completes a second portion of an object detection algorithm and outputs a result.

14) The camera system of claim 13 wherein said vision processor comprises a master processor and one or more tile-based processors.

15) A camera system of claim 13, wherein the object detection algorithm is a convolutional neural network comprising at least one convolutional layer.

16) The camera system of claim 13, wherein said first portion of a convolutional neural network algorithm comprises at least two convolutional layers.

17) The camera system of claim 13, wherein said first portion of a convolutional neural network algorithm comprises at least three convolutional layers.

18) The camera system of claim 13, wherein said first portion of a convolutional neural network algorithm comprising at least two convolutional layers and a pooling layer.

19) A camera system of claim 14, wherein the object detection algorithm is a convolutional neural network comprising at least one convolutional layer.

20) The camera system of claim 14, wherein said first portion of a convolutional neural network algorithm comprising at least two convolutional layers and a pooling layer.

21) The camera system of claim 13, wherein said vision processor executes an object recognition algorithm and outputs an indication on whether one or more objects of interest are included in the image; when indication is that no objects of interest are present in the image the camera and vision processor are placed in a mode to minimize energy consumption for a time equal to at least one frame period at the specified frame rate.
